(19) United States
(12) Patent Application Publication
(10) Pub. No.: US 2007/0039986 A1
(43) Pub. Date: Feb. 22, 2007

(54) Tool caddy for use with a wheelbarrow or a cart

(76) Inventor: Barbara R. Tomasi, Bellevue, ID (US)

Correspondence Address: W. Edward Johansen, 11661 San Vicente Boulevard, Los Angeles, CA, 90046, US

(21) Appl. No.: 11/210,257

(22) Filed: Aug. 22, 2005

(51) Int. Cl. B60R 9/00; B60R 7/00; B60R 11/00

(52) U.S. Cl. 224/401; 224/563; 224/572

(57) ABSTRACT

A tool caddy is for use with a wheelbarrow that has an external side panel. The tool caddy includes a substrate, first a plurality of pockets, a second plurality of loops and an attaching mechanism. The substrate covers the external side panel. The pockets are disposed on and mechanically coupled to the substrate. Each pocket is adapted to receive a tool. The loops are disposed in a serial and concentric alignment and mechanically coupled to the substrate and are adapted to receive a tool with an elongated handle that is disposed in each loop.

### BACKGROUND OF THE INVENTION

1. Field of the Invention

The present invention relates to a tool caddy for use with a wheelbarrow or a cart.

2. Description of the Prior Art

Gardening and other outdoor projects are as popular today as they were decades ago. In addition to the popular hobby of gardening or landscaping, craft projects are often performed outside or small carpentry or automotive projects. It is necessary to keep a variety of small tools handy for easy access during any of these projects. For example, a person may need to perform a variety of chores in the yard, such as weeding, watering, trimming hedges, and/or planting, most which require a waste receptacle and a variety of specific tools. Many people prefer to keep other personal comfort items with them, such as their cell phone and soft drink. As the yard worker moves from work site to work site within the yard, it can be quite awkward to keep track of and to transport all of these items with the user to avoid misplacement.

Gardeners, tradesmen, workmen and the like often carry and transport their tools and/or equipment in an open top carrying case. An open top carrying case enables quick access to the contents of the case. Such a case also facilitates carrying of multiple tools and items necessary for performance of work. Desirable features of such a carrying case are that it be rugged, flexible, yet have a certain degree of structural integrity so that the tools or items carried in the case will be protected and will not deform the case due to their weight. Additionally, a carrying case for tools should be capable of including special storage pockets and other features for separating and transporting tools. Also, handles or carrying straps are desirable features for a carrying case.

U.S. patent application Ser. No. 2004/0016666 teaches a storage and carrying case that includes semi-rigid spaced end panels and a semi-rigid bottom panel all joined together by means of a fabric over layer and a fabric under layer which are stitched together by a binding which also connects to front and back panels to form an enclosure for tools or the like. A single binding may thus be utilized to join all of the flexible fabric materials which retain the semi-rigid or rigid panels forming the enclosure.

Portable wheeled carts for use in lawn and garden work are commonly used by both commercial and home users. However, the home user is likely to choose a less expensive and lower quality brand name as compared to his or her commercial counterpart who is more likely to need a portable cart for conveying relatively heavy loads on a frequent basis and who requires sustained durability lasting many years. The home user who typically performs lawn and garden work only on weekends, on the other hand, is generally willing to opt for a non-commercial model if sufficient savings in cost can be achieved. However, concomitant with the cost savings is a general reduction in the durability and functionality of the cart. Moreover, unlike the commercial user, the home user may not have separate facilities or carts for storing various lawn and garden supplies and tools in an efficient manner during non-use periods. Accordingly, the home user's yard and garden supplies and tools are typically stored in the garage with other household items and may often become misplaced during extended periods of non-use, thus causing frustration to the homeowner seeking to resume work about the house. In addition, due to the relatively limited capacity of most lawn and garden carts, the user frequently makes repeated back-and-forth trips between the place of work and storage area to acquire all the supplies needed for the particular job to be performed. Furthermore, when lawn carts such as conventional wheelbarrows are not being used, they provide no secondary function such as the capability of efficiently storing lawn and garden supplies.

Wheelbarrows are well known as a tool for moving heavy loads for a short distance. Typically, a wheelbarrow has a container made from sheet metal supported by a forward wheel and two rear legs. The handles are typically formed as a pair of parallel pipes extending to the rear of the container.

U.S. Pat. No. 6,193,265 teaches a wheelbarrow which includes a container, a pair of handles rigidly connected to the container and a support system including at least one wheel assembly for supporting the container. The container has a longitudinal-vertical plane of symmetry. The wheelbarrow has a number of clips, deployed along side walls of the container, for holding a long-handled gardening tool. The clips have a snap-in design configured to engage a number of shaped recesses in the side walls. The shaped recesses are formed as recessed parallel-sided channels having sides configured to abut parallel edges of clips so as to prevent the clips from swiveling. Typically, the depth of the recesses is substantially equal to the thickness of the clip so that, when assembled, the clip surface lies roughly flush with the rim of the container. Clip is provided with a barbed pin which engages a corresponding hole in the upper edge of side wall. By providing at least two clips spaced along the side wall, the long-handled tool can be retained in a stable manner for convenient transportation and easy access when needed.

U.S. Pat. No. 5,833,250 teaches a garden cart for carting around a variety of garden tools to a desired location. U.S. Pat. No. 3,894,748 teaches a lawn and garden cart for transporting and storing garden implements having extended thin handles and head portions. While these carts fulfill their respective, particular objectives and requirements, the need remains for a device that is more compact and easier to transport, capable of lifting heavier materials and stores more tool articles than previous lawn and garden carts.

U.S. Pat. No. 6,808,185 teaches a garden tool caddy and dolly combination which includes a dolly including a generally planar frame has an upper end and a lower end. A pair of wheels is rotatably mounted to the lower end. A platform is attached to and extends away from the lower end. The platform lies in a plane orientated generally perpendicular to a plane of the frame. A plurality of brackets is attached to the frame. At least one elongated tool is selectively attached to the frame by the brackets.

U.S. Pat. No. 5,318,315 teaches a portable wheeled cart for work in yard and garden that includes a body having a bottom wall and a pair of opposing sidewalls extending upwardly from the bottom wall. The sidewalls include a plurality of open-ended passageways defined therein for receiving handles of yard tools. In the wheelbarrow position, the yard tools and supplies can be readily transported from one location to another without requiring repeated trips between locations.

Gardeners have long used trashcans to haul their tools and to collect debris. To further reduce their labors, many gardeners have taken to employing conventional hand trucks and wagons to move tool- and debris-filled trashcans over the ground. Special-purpose dollies have been proposed for the purpose of toting trashcans and long-handled garden tools like rakes, shovels and brooms, but these have not seen widespread acceptance or great commercial success. Conventional hand trucks and wagons lack means for securing trashcans in place and for supporting gardening tools remote from a trashcan. Bungee cords are, thus, used to weakly secure a trashcan in place on a hand truck or wagon. Furthermore, gardening tools are often carried along with garden waste in a trashcan positioned on a hand truck or wagon. Unfortunately, tools that are small in size are sometimes buried in the waste, forgotten and discarded. Special purpose dollies pose a number of problems for users. Perhaps their principal problem is that trashcans are more-or-less permanently secured thereto, making the emptying of accumulated trash and garden debris a time-consuming and burdensome task. Furthermore, these dollies cannot be converted to normal use whereby items other than trashcans and a few tools can be easily transported. Finally, these dollies are costly and cumbersome in their construction. One does not often see them in use.

U.S. patent application Ser. No. 2004/0061298 teaches a tool caddy that includes a pair of hinged arms for encircling a trashcan. A mounting bracket is hingedly secured to the inner end of each of the hinged arms for releasably securing the arm to a hand truck. A pair of cooperating locking elements is positioned at the outer ends of the hinged arms for releasably joining the hinged arms together. At least one clip is secured to one of the hinged arms for releasably grasping and carrying a tool.

U.S. patent application Ser. No. 2004/0055979 teaches a caddy for supporting and transporting cleaning and/or garden supplies on the rim of a waste container. The caddy couples a tray made of plastic or similar rigid material that attaches and extends laterally from the outer rim of a waste container. Formed on opposite sides of the tray is a concaved lip and a straight lip. Formed on the tray is a large, centrally aligned and downward extending cavity with concave and straight side walls that extend parallel to the concave and straight side walls on the tray. Slots are created between the lip and side walls of the cavity that are sufficiently wide to receive the curved or straight upper edges of a waste container. Formed around the cavity is a plurality of smaller holes or openings designed to hold such items as a cellular phone, a soda can, pliers, shears, small shovel, etc. At least two adjustable legs are attached to the bottom surface of the cavity that extends laterally in opposite directions to press against the outer surface of the outer container. During use, the caddy is placed on the outside edge of the waste container so that the large opening of the waste container is not blocked.

U.S. Pat. No. 6,473,905 teaches garments which have particular use during gardening activities. The garments each broadly include a protective panel to be worn in the front of the user, at least one pad connected to the protective panel for protecting a user's knees when kneeling and devices for holding implements that may be needed by the user attached to the protective panel. The holding devices may include straps secured to the protective panel, pockets attached to the protective panel, and/or VELCRO tabs attached to the protective panel.

U.S. Pat. No. 6,839,917 teaches a work garment for use by gardeners to protect their clothing while working and for holding articles in pockets, which may be changed by snapping on special pockets for different uses of the garment. The pockets can be of different sizes and be segmented or not for holding different articles. The garment may have permanent and snap-on pockets. The garment is fastened around the waist of the wearer by a belt and the legs fastened by straps around the wearer's legs.

The inventor hereby incorporates all of the above referenced patents into his specification.

### SUMMARY OF INVENTION

The present invention is generally directed to a tool caddy for use with a wheelbarrow that has an external side panel.

In a first aspect of the present invention the tool caddy includes a substrate, a plurality of pockets and an attaching mechanism. The substrate covers the external side panel. The pockets are disposed on and mechanically coupled to the substrate. Each pocket is adapted to receive a tool.

In a second aspect of the present invention the tool caddy includes a substrate, a plurality of loops and an attaching mechanism. The loops are disposed in a serial and concentric alignment and mechanically coupled to the substrate and are adapted to receive a tool with an elongated handle that is disposed in each loop.

Other aspects and many of the attendant advantages will be more readily appreciated as the same becomes better understood by reference to the following detailed description and considered in connection with the accompanying drawing in which like reference symbols designate like parts throughout the figures.

The features of the present invention which are believed to be novel are set forth with particularity in the appended claims.

### DESCRIPTION OF THE DRAWINGS

FIG. 1 is a side view of a wheelbarrow that has attached to it a tool caddy according to the present invention.

FIG. 2 is a rear view of the wheelbarrow and tool caddy of FIG. 1.

FIG. 3 is a front view of the wheelbarrow and tool caddy of FIG. 1.

FIG. 4 is exploded top plan view of the tool caddy of FIG. 1.

FIG. 5 is a partial cross-section view of a tool caddy according to the present invention that is bolted to a wheelbarrow.

### DESCRIPTION OF THE PREFERRED EMBODIMENT

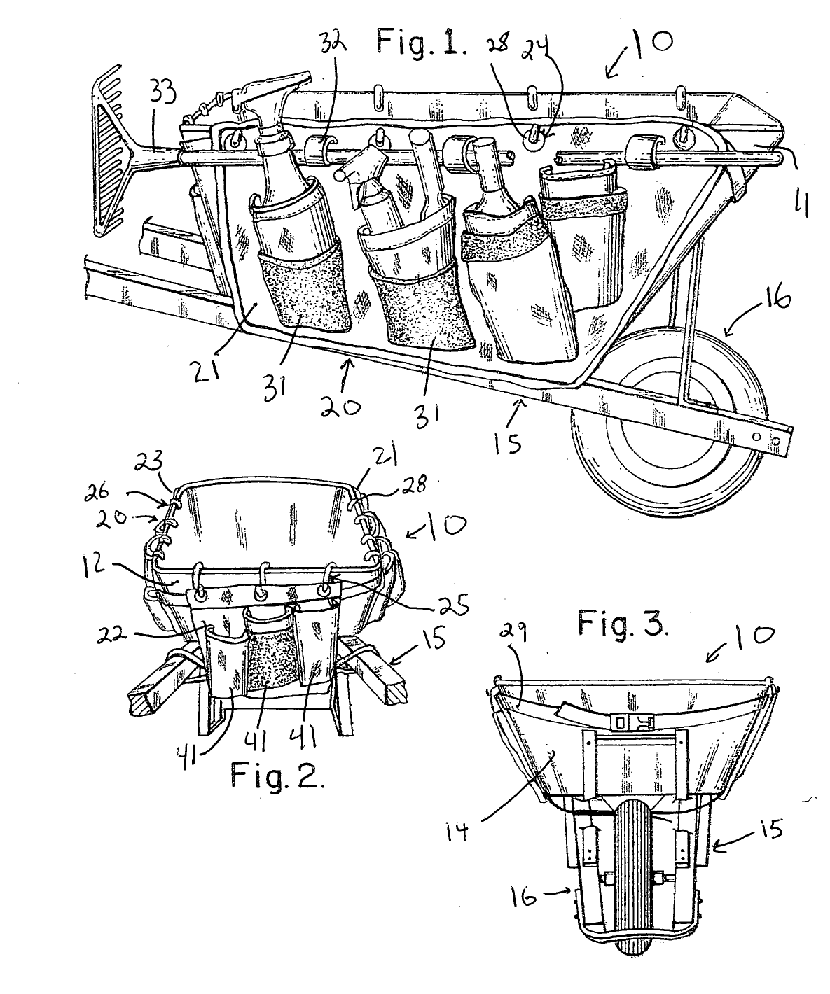

Referring to FIG. 1 in conjunction with FIG. 2 and FIG. 3 a wheelbarrow 10 includes a container that has a right external side panel 11, a rear external panel 12, a left side external panel 13 and a front external panel 14. The container 10 may include a support mechanism 15 that has at least one wheel assembly 16 for supporting the container 10 thereby forming a wheelbarrow. A support mechanism may include at least two wheels assembly for supporting the container 10 thereby forming a cart.

Still referring to FIG. 1 in conjunction with FIG. 2 and FIG. 3 a tool caddy 20 also includes a first substrate 21, a second substrate 22 and a third substrate 23. The first, second and third substantially cover the right external side panel 11, the rear external panel 12 and the left side external panel 13. The first, second and third substrates 21, 22 and 23 may be either formed out of a flexible material that is selected from a group consisting of canvas, sailcloth, cordura, oilcloth, treated heavy fabrics, nylon and pvc-type fabric or a rigid material that is selected from a group of materials consisting of metal, plastic and wood.

Still further referring to FIG. 1 in conjunction with FIG. 2 and FIG. 3 the tool caddy 20 also includes a first attaching mechanism 24, a second attaching mechanism 25 and a third attaching mechanism 26. The first, second and third attaching mechanism 24, 25 and 26 are selected from a group consisting of gromets 27 and hooks 28, including S hooks and wire hooks, clamps, nuts and bolts, screws and VELCRO fastening devices. Webbing 29 goes around the container 10 so that when the webbing 29 is tightened around the container 10 a closure to snug it up may be required and may be a buckle, tie-down clamp, snap, button, VELCRO fastening devices, bungee with a hook or an elastic cording with a keeper thereby forming heavy duty drawstring.

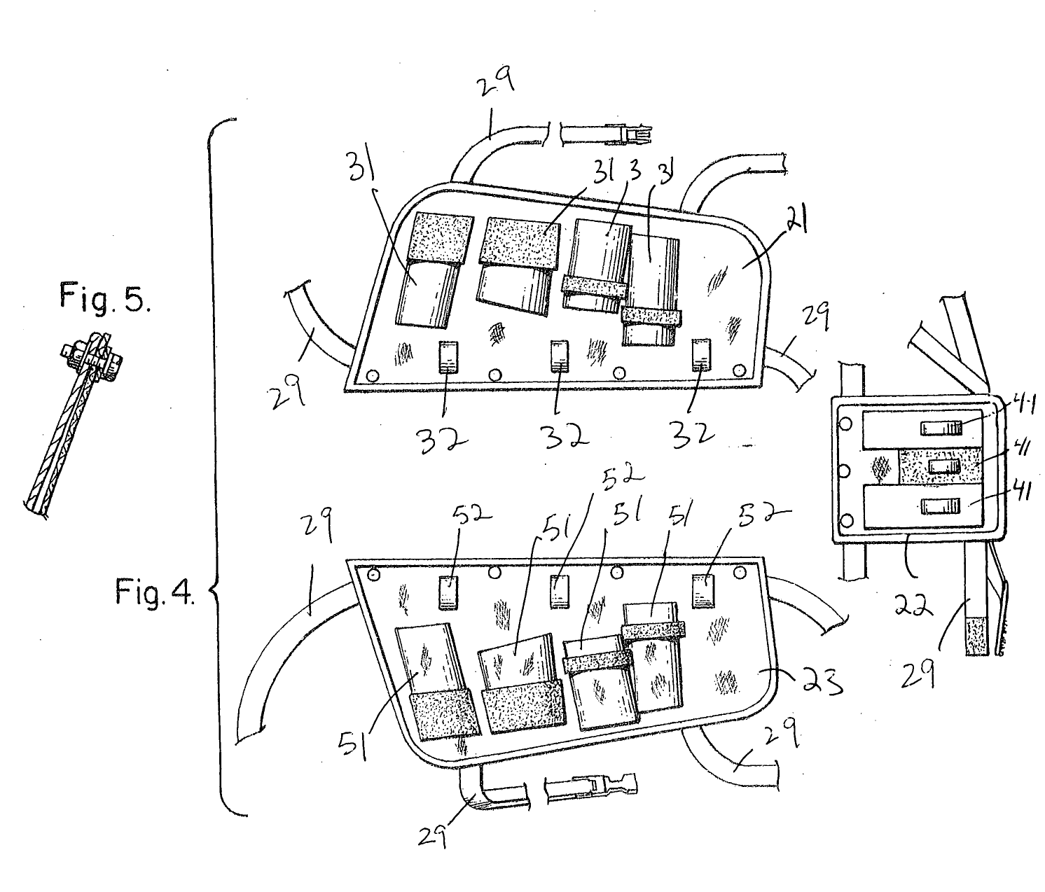

Referring to FIG. 4 in conjunction with FIG. 1 the tool caddy 20 has a first plurality of pockets 31 and a first plurality of loops 32. The pockets 31 are randomly disposed on and mechanically coupled to the first substrate 21. Each pocket 31 is adapted to receive a tool. The loops 32 are disposed on and mechanically coupled to the second substrate 22. The loops 32 may be disposed in serial and concentric alignment so that they are adapted to a tool, for example a rake 33, with an elongated handle that may be disposed in each of the loops 32.

Referring to FIG. 4 in conjunction with FIG. 2 the tool caddy 20 has a second plurality of pockets 41. The pockets 31 are randomly disposed on and mechanically coupled to the second substrate 22. Each pocket 41 is adapted to receive a tool.

Referring again to FIG. 4 in conjunction with FIG. 1 the tool caddy 20 has a third plurality of pockets 51 and a second plurality of loops 52. The pockets 51 are randomly disposed on and mechanically coupled to the third substrate 23. Each pocket 51 is adapted to receive a tool. The loops 52 are disposed on and mechanically coupled to the third substrate 23. The loops 52 may be disposed in serial and concentric alignment so that they are adapted to a tool, for example a hoe, with an elongated handle that may be disposed in each of the loops 52.

From the foregoing it can be seen that a tool caddy for use with a wheelbarrow or a cart has been described. It should be noted that the sketches are not drawn to scale and that distances of and between the figures are not to be considered significant.

Accordingly it is intended that the foregoing disclosure and showing made in the drawing shall be considered only as an illustration of the principle of the present invention.

What is claimed is:

1. A tool caddy for use with a container having a right external side panel, said tool caddy comprising:
a. a first substrate that substantially covers the right external side panel;
b. a first plurality of pockets which are disposed on and mechanically coupled to said first substrate and each of which is adapted to receive a tool; and
c. a first attaching mechanism that mechanically couples said first substrate to the right external side panel of the container.

2. A tool caddy according to claim 1 wherein the tool caddy also includes a first plurality of loops which are disposed on and mechanically coupled to said first substrate.

3. A tool caddy according to claim 1 wherein the container also has a front external panel, a left external side panel and a rear external panel and said tool caddy also includes:
a. a second substrate that substantially covers the left external side panel;
b. a second plurality of pockets which are randomly disposed on and mechanically coupled to said second substrate and each of which is adapted to receive a tool;
c. a second plurality of loops which are mechanically coupled to said second substrate; and
d. a second attaching mechanism that mechanically couples said second substrate to the left external side panel of the container.

4. A tool caddy according to claim 3 wherein the tool caddy also includes:
a. a third substrate that substantially covers the rear external panel;
b. a third plurality of pockets which are randomly disposed on and mechanically coupled to said third substrate and each of which is adapted to receive a tool; and
c. a third attaching mechanism that mechanically couples said third substrate to the rear external panel of the container.

5. A tool caddy according to claim 3 wherein the tool caddy also includes:
a. a fourth substrate that substantially covers the front external panel;
b. a fourth plurality of pockets which are randomly disposed on and mechanically coupled to said fourth substrate and each of which is adapted to receive a tool; and
c. a fourth attaching mechanism that mechanically couples said fourth substrate to the rear external panel of the container.

6. A tool caddy according to claim 1 wherein the container includes a support mechanism including at least one wheel assembly for supporting the container thereby forming a wheelbarrow.

7. A tool caddy according to claim 1 wherein the container includes a support mechanism including at least two wheels assembly for supporting the container thereby forming a cart.

8. A tool caddy according to claim 1 wherein said pockets are randomly disposed on and mechanically coupled to said first substrate and each of which is adapted to receive a tool.

9. A tool caddy according to claim 1 wherein said loops are disposed in a serial and concentric alignment and mechanically coupled to said first substrate and are adapted to receive a first tool with an elongated handle that is disposed in each of said loops.

10. A tool caddy for use with a container having a left external side panel, said tool caddy comprising:
a. a first substrate that substantially covers the left external side panel;
b. a first plurality of pockets which are disposed on and mechanically coupled to said first substrate and each of which is adapted to receive a tool; and
c. a first attaching mechanism that mechanically couples said first substrate to the left external side panel of the container.

11. A tool caddy according to claim 1 wherein the tool caddy also includes a first plurality of loops which are disposed on and mechanically coupled to said first substrate.

12. A tool caddy according to claim 1 wherein the container also has a front external panel, a right external side panel and a rear external panel and said tool caddy also includes:
a. a second substrate that substantially covers the rear external panel;
b. a second plurality of pockets which are randomly disposed on and mechanically coupled to said second substrate and each of which is adapted to receive a tool;
c. a second plurality of loops which are mechanically coupled to said second substrate; and
d. a second attaching mechanism that mechanically couples said second substrate to the rear external panel of the container.

13. A tool caddy for use with a container having a rear external panel, said tool caddy comprising:
a. a first substrate that substantially covers the rear external panel;
b. a first plurality of pockets which are disposed on and mechanically coupled to said first substrate and each of which is adapted to receive a tool; and
c. a first attaching mechanism that mechanically couples said first substrate to the rear external side panel of the container.

14. A tool caddy according to claim 1 wherein said first substrate is formed out of a flexible material from a group of materials consisting of canvas, sailcloth, cordura, oilcloth, treated heavy fabrics, nylon and pvc-type fabric.

15. A tool caddy according to claim 1 wherein said first substrate is formed out of a rigid material from a group of materials consisting of metal, plastic and wood.

16. A tool caddy according to claim 1 wherein said attaching mechanisms are selected from a group consisting of gromets and hooks, including S hooks and wire hooks, clamps, nuts and bolts, screws and VELCRO fastening devices.

17. A tool caddy according to claim 1 wherein said attaching mechanisms is a webbing wherein said webbing goes around the container so that when said webbing is tightened around the container a closure to snug it up is required, which could be a buckle, tie-down clamp, snap, button, VELCRO fastening devices, bungee with a hook, an elastic cording with a keeper forming heavy duty drawstring.
